(19) United States
(12) Patent Application Publication
(10) Pub. No.: US 2004/0234417 A1
(43) Pub. Date: Nov. 25, 2004

(54) Fluorescence biosensor chip and fluorescence biosensor chip arrangement

(75) Inventors: Meinrad Schienle, Ottobrunn (DE); Ralf Brederlow, Munchen (DE); Franz Hofmann, Munchen (DE); Martin Jenkner, Planegg (DE); Johannes R. Luyken, Munchen (DE); Christian Paulus, Weilheim (DE); Petra Schindler-Bauer, Vaterstetten (DE); Roland Thewes, Grobenzell (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/803,175

(22) Filed: Mar. 16, 2004

Related U.S. Application Data
(63) Continuation of application No. PCT/DE02/02954, filed on Aug. 12, 2002.

(30) Foreign Application Priority Data
Sep. 17, 2001 (DE) 101 45 701.4

(51) Int. Cl. G01N 21/64

(52) U.S. Cl. 422/82.08

(57) ABSTRACT

Fluorescence biosensor chip having a substrate, at least one electromagnetic radiation detection device arranged in or on the substrate, an optical filter layer arranged on the substrate, and an immobilization layer, which is arranged on the optical filter layer and immobilizes capture molecules. The electromagnetic radiation detection device, the optical filter layer, and the immobilization layer are integrated in the fluorescence biosensor chip.

### CROSS-REFERENCE TO RELATED APPLICATION

This application is a continuation of International Patent Application Serial No. PCT/DE02/02954, filed Aug. 12, 2002, which published in German on Apr. 3, 2003 as WO 03/027676, and is incorporated herein by reference in its entirety.

### FIELD OF THE INVENTION

The invention relates to a fluorescence biosensor chip and a fluorescence biosensor chip arrangement.

### BACKGROUND OF THE INVENTION

Biotechnology and genetic engineering have increasingly gained in importance in recent years. One basic technique in biotechnology and genetic engineering is to be able to detect biological molecules such as DNA (deoxyribonucleic acid) or RNA, proteins, polypeptides, etc. Principally biomolecules in which hereditary information is coded, in particular DNA molecules (deoxyribonucleic acid), are of great interest for many medical applications. Therefore, detection methods are acquiring increasing importance in the industrial identification and assessment of new medicaments originating organically and from genetic engineering. Said detection methods open up diverse applications for example in medical diagnosis, in the pharmacology industry, in the chemical industry, in foodstuffs analysis and also in ecological and foodstuffs technology.

A DNA is a double helix constructed from two interlinked helical individual chains so-called half strands. Each of these half strands has a base sequence, the hereditary information being defined by means of the order of the bases (adenine, guanine, thymine, cystosine). DNA half strands have the characteristic property of binding highly specifically only with very particular other molecules. Therefore, the docking of one nucleic acid strand to another nucleic acid strand presupposes that the two molecules are complementary to one another. Clearly, the two molecules have to match one another like a key and the matching lock (so-called key-lock principle).

This naturally prescribed principle can be used for the selective detection of molecules in a liquid to be examined. The basic idea of a biochip sensor based on this principle consists in firstly so-called capture molecules being applied (e.g. by means of microdispensing) and immobilized on a substrate made of a suitable material, i.e. being permanently fixed at the surface of the biochip sensor. In this connection, it is known to immobilize biomolecules with thiol groups (SH groups) at gold surfaces.

Such a biochip sensor having a substrate and capture molecules which are bound thereto and are sensitive for example to a particular DNA half strand to be detected is usually used for examining a liquid with regard to the presence of DNA half strands that are complementary to the capture molecules. For this purpose, the liquid which is to be examined with regard to the presence of a particular DNA half strand is to be brought into operative contact with the immobilized capture molecules. If a capture molecule and a DNA half strand to be examined are mutually complementary, then the DNA half strand hybridizes to the capture molecule, i.e. it is bound thereto. If, on account of this binding, the value of a metrologically detectable physical quantity changes in a characteristic manner, then the value of this quantity can be measured and the presence or absence of a DNA half strand in a liquid to be examined can be detected in this way.

The principle described is not restricted to the detection of DNA half strands. Rather, further combinations of capture molecules applied on the substrate and molecules to be detected in a liquid to be examined are known. Thus, by way of example, it is possible to use nucleic acids as capture molecules for peptides or proteins which bind in nucleic-acid-specific fashion. Furthermore, it is known to use peptides or proteins as capture molecules for other proteins or peptides which bind the capture peptide or the capture protein. Furthermore, the use of low-molecular-weight chemical compounds as capture molecules for proteins or peptides which bind to said low-molecular-weight compounds is of importance. Low-molecular-weight chemical compounds are those chemical compounds which have less than about 1700 Daltons (molecular weight in grams per mol). Conversely, it is also possible to use proteins and peptides as capture molecules for low-molecular-weight compounds that are possibly present in a liquid to be examined.

Electronic detection methods are known for the detection of the binding effected between the capture molecule applied on the substrate and the molecule to be detected which is present in the liquid to be examined. Thus, by way of example, it is possible to measure the value of the capacitance between two electrodes at which capture molecules are immobilized. If molecules to be detected hybridize with the capture molecules, then the value of the capacitance is altered in a characteristic manner and the hybridization event can be detected by means of an electrical signal. Such a DNA sensor is described for example in [1]. However, the detection sensitivity of such electronic detection methods for DNA molecules is limited. Moreover, problems occur such that sensitive biomolecules (e.g. DNA, proteins) may be decomposed if they come into direct contact with free electrical charges at the surface of electrodes. It is known that many proteins denature outside a range of pH values that is characteristic of each protein.

As an alternative, optical methods are used for the detection of the hybridization of molecules to be detected. A hybridization event can be detected optically if a hybridized molecule has a fluorescent dye with the ability to emit electromagnetic fluorescence radiation in a characteristic wavelength range once the fluorescence dye has been excited by absorption of light of a primary wavelength range. The biomolecules, for example DNA half strands, to be detected which are contained in the analyte are to be coupled for this purpose to a fluorescence marker by means of a suitable linker molecule. If the biomolecules to be detected which are fluorescence-marked in this way have hybridized with the capture molecules immobilized on the sensor surface, and if light of a suitable wavelength is radiated in, which light can be absorbed by the fluorescence marker, then the light that is radiated in is absorbed by the fluorescence markers and light quanta of a different wavelength are reemitted (resonance fluorescence). The intensity of the fluorescence light reemitted from the sensor surface is then a measure of the number of docked molecules to be detected. The reemitted fluorescence light in principle has a longer wavelength (and lower energy) than the exciting primary light. This physical effect makes it possible to separate the fluorescence light from the exciting light by using suitable optical filters which absorb, reflect and transmit in wavelength-dependent fashion. If these filters are chosen in a suitable manner to be opaque to the wavelength of the primary light but, in contrast, to be transmissive to the wavelength of the reemitted light, then the reemitted light can be detected by means of detectors arranged downstream of the filter.

The intensity of the fluorescence light to be detected is often a few orders of magnitude lower than the intensity of the exciting primary light, which makes it more difficult for the fluorescence light to be detected metrologically and limits the detection sensitivity of the sensor. Furthermore, the sensor is intended to enable the quantitative detection of the intensity of the fluorescence tight over a largest possible range (high dynamic range). What is more, a good spatial resolution is demanded of a sensor arrangement since the sensor elements of the arrangement are often equipped with different capture molecules in order to be able to simultaneously detect different molecules to be detected. Therefore, high requirements are made of the quality of the optics of a read-out device.

Known read-out devices typically use a laser scanner for excitation and a confocal microscope for detection of the emitted light. Furthermore, an optical cut-off filter which suppresses the exciting wavelength (long wave pass) is inserted into the detection beam path.

FIG. 1A shows a fluorescence biosensor chip 100 known from WO 00/12759. The fluorescence biosensor chip 100 has a light source 101, which emits light 100a of a wide wavelength range. The light 100a emitted by the light source 101 passes through the light source filter 102, as a result of which essentially monochromatic primary light is incident on the biochip 103. A biological sample is provided on the biochip 103, the biological molecules having a fluorescence marker. The fluorescence markers of the biological molecules on the biochip 103 are set up in such a way that they absorb the light from the light source 101 which is transmitted through the light source filter 102. After the light has been absorbed, the fluorescence markers reemit light of a second wavelength, which differs from the wavelength of the incident light. The reemitted light has a longer wavelength than the primary light 100a (red shift). The light reemitted by the fluorescence markers of the biomolecules on the biochip 103 impinges on the lens 104, which is set up in such a way that it images the individual light signals onto the CCD sensor device 106 in a positionally correct manner. Before the light impinges on the CCD sensor device 106, it passes through the sensor filter 105. The sensor filter 105 is set up in such a way that it is transmissive to the wavelength of the reemitted light, whereas it is opaque to the wavelength of the primary light. The CCD sensor arrangement 106 (charge coupled device) registers the fluorescence events on the biochip 103. However, the adjustment of the fluorescence biosensor chip 100, which has a high outlay in terms of apparatus, said adjustment being necessary on account of the optics or the complicated measurement system, is complicated, which results in the fluorescence biosensor chip 100 having a user-friendliness that is in need of improvement. This is disadvantageous. Furthermore, the fluorescence biosensor chip 100 is expensive since it has expensive individual components such as the CCD sensor arrangement 106.

A further fluorescence biosensor chip 110 is known from WO 99/27140 and Vo-Dinh, T (1998) “Development of a DNA biochip principle and applications” Sensors and Actuators B51:52-59. and is shown in FIG. 1B. The fluorescence biosensor chip 110 has a light source 111, which emits light 111a of a primary wavelength range. The light 11a emitted by the light source 111 passes firstly through an optical element 112 and then through a light source filter 103. The light source filter 103 is set up in such a way that it is transmissive only to electromagnetic radiation of a specific wavelength or a specific wavelength range. The light transmitted through the light source filter 113 is deflected by means of an optical reflector element 114 and thereby passes into cavities 116 of a sample holder 115, in which the biological molecules to be examined are arranged. If a hybridization event has taken place in one of the cavities 116, i.e. if molecules having a fluorescence marker have hybridized with the capture molecules in one of the cavities 116, then suitably chosen fluorescence markers may absorb the light from the light source 111 which is incident on the cavities 116 and reemit it with a wavelength shifted toward longer wavelengths. The primary light and the reemitted light pass onto the sensor filter 117, which is transmissive to light of the wavelengths of the fluorescence radiation, whereas it is essentially opaque to light of the wavelengths of the primary light. Therefore, ideally exclusively the fluorescence light passes onto the photodetectors 118 on the biochip 119. A signal on the photodetectors 118 can be detected only when a hybridization event has taken place on the cavity that spatially corresponds to a photodetector 118. As indicated by the dotted lines in FIG. 1B, the individual components of the fluorescence biosensor chip 110 can be assembled by the user. Although this reduces the spatial separation of the components which leads to a large spatial extent, the fluorescence biosensor chip 110 has low operating convenience. Furthermore, the fluorescence biosensor chip 110 is too expensive for many applications.

The fluorescence biosensor chips known from the prior art have a complicated construction and a complex structure, are large and thus expensive. Furthermore, the fluorescence biosensor chips known from the prior art are in part not very user-friendly. A further sensor chip is known from Kong, S H, Correia, G, de Graaf, G, Bartek, M, Wolfenbuttel, R F (1998) “CMOS compatible optical sensors with thin film interference filters; fabrication and characterization” Workshop on Semiconductor Advances on Future Electronics SAFE′98, 291-294.

(http://www.stw.nl/programmas/safe/safe98/proceedings/kong.pdf). This sensor chip has a photodiode produced in accordance with the CMOS process and an integrated Fabry-Perot filter. A Fabry-Perot filter is constructed from two partly transmissive mirrors which are arranged at a defined distance from one another, the inner area of the first mirror ideally being totally reflective and the inner area of the other mirror having a reflectivity only a little less than one. If incident tight passes through the first mirror, then the light is multiply reflected at the inner area of the second mirror and then at the inner area of the first mirror, then again at the inner area of the second mirror, etc., a small portion also being transmitted through the second mirror on each reflection at the inner area of the second mirror. The transmitted individual rays interfere in such a way that the Fabry-Perot interferometer is transmissive only to light of particular wavelengths. However, the biosensor known from Kong et al. is not provided for the detection of biological molecules.

The same applies to a sensor arrangement known from U.S. Pat. No. 5,648,653. A camera based on photodiodes integrated in a substrate is known from U.S. Pat. No. 5,648,653 a pixel of the image to be recorded by the camera being composed from three photodiodes which three photodiodes are covered with a red, a green and a blue filter in accordance with the RGB system.

DE 197 31 479 A1 discloses an apparatus and a method with a field light source array for an integrated sample detection.

DE 199 40 752 A1 discloses a method for producing a carrier coated with biologically or chemically functional materials.

DE 199 40 751 A1 describes a light emission detection apparatus having an LCD matrix as a two-dimensional controllable light source and a CCD matrix facing and opposite the LCD matrix and serving for the detection of the optical behavior of a respective sample substance situated between LCD matrix and CCD matrix.

DE 100 38 080 A1 discloses a method and an apparatus for the spatially resolved fluorescence-optical detection of substances immobilized on a surface of a planar carrier.

In a hybridization detection method known from JP 2000235035 A, the quantity of probes fixed on spots of a glass plate is determined by causing fluorescent material for identifying the probes to emit light. The quantity of sample hybridized with the probes is determined by causing fluorescent material for identifying the sample to emit light.

WO 01/03833 A1 discloses an analysis substrate using the transmission of fluorescence light.

DE 199 47 616 A1 discloses a method and a device for determining substances, such as e.g. DNA sequences, in a sample.

### SUMMARY OF THE INVENTION

The invention is based on the problem of providing a less complex and thus more cost-effective fluorescence biosensor chip.

The problem is solved by means of a fluorescence biosensor chip and a fluorescence biosensor chip arrangement having the features in accordance with the independent patent claims.

A fluorescence biosensor chip has a substrates at least one detection device arranged in or on the substrate and serving for the detection of electromagnetic radiation, an optical filter layer arranged on the substrate, and an immobilization layer arranged on the optical filter layer and serving for the immobilization of capture molecules, the detection device, the filter layer and the immobilization layer being integrated in the fluorescence biosensor chip.

According to the invention, then, all the components of the fluorescence biosensor chip are integrated in the fluorescence biosensor chip. The fact that all the components of the fluorescence biosensor clip are thereby spatially very close together means that the fluorescence biosensor chip has a very small size. A very compact fluorescence biosensor chip is thereby provided. The immobilization layer, which serves as a sensor plane according to the invention and the detection devices integrated in the substrate, which serve for the indirect detection of hybridization events, are arranged, in terms of the order of magnitude, typically less than 100 μm away from one another, which results in a good spatial resolution of the fluorescence biosensor chip. Moreover, the fluorescence biosensor chip according to the invention is designed in such a way that it can be produced by means of standardized CMOS-compatible semiconductor-technological methods. Consequently, it is not necessary to develop expensive machines for producing the fluorescence biosensor chip, as a result of which the fluorescence biosensor chip can be produced cost-effectively and with a low outlay. Moreover, the individual sensors of the fluorescence biosensor chip can be produced from cost-effective materials.

In the case of the fluorescence biosensor chip of the invention, the substrate is preferably produced from silicon material. Thus, the substrate may be a silicon wafer, for example.

In accordance with a preferred exemplary embodiment, the at least one detection device of the fluorescence biosensor chip according to the invention has at least one photodiode which is set up in such a way that electromagnetic radiation of a first wavelength range can be detected thereby.

The fact that the at least one detection device is configured as a photodiode integrated in the substrate means that a sensitive detector for electromagnetic radiation which can be produced cost-effectively is provided.

Preferably, the optical filter layer is set up in Such a way that the optical filter layer absorbs and/or reflects electromagnetic radiation of a second wavelength range, at least part of the first wavelength range lying outside the second wavelength range.

Clearly, the optical filter layer is set up in such a way that it absorbs and/or reflects that part of the electromagnetic radiation incident on the surface of the optical filter layer which is intended to be shielded from the photodiode since said electromagnetic radiation is not the radiation to be detected. The fact that at least part of the first wavelength range in which the photodiode is sensitive to the detection of electromagnetic radiation lies outside the second wavelength range ensures that the electromagnetic radiation to be detected by the photodiode can at least partially penetrate through the optical filter layer. As a result, the absorption layer suppresses the irradiation of the photodiodes with such electromagnetic radiation which does not originate from molecules to be detected which are hybridized to the immobilization layer, for example scattered light from the surroundings or primary light for the excitation of fluorescence markers of molecules to be detected which, if appropriate, are hybridized to the immobilization layer. Therefore, the detection sensitivity of the fluorescence biosensor chip can be increased by means of a suitable choice of the optical filter layer.

The optical filter layer preferably has at least one bandpass filter and/or at least one cut-off filter.

A bandpass filter is understood hereinafter to be an optical filter which is essentially opaque to electromagnetic radiation in a wavelength range between a lower limit wavelength and an upper limit wavelength, whereas the bandpass filter is essentially transmissive to electromagnetic radiation below the lower limit wavelength and above the upper limit wavelength.

A cut-off filter is understood hereinafter to be an optical filter which essentially either is opaque to electromagnetic radiation below a limit wavelength and transmissive to electromagnetic radiation above the limit wavelength, or is opaque to electromagnetic radiation above a limit wavelength and is transmissive to electromagnetic radiation below the limit wavelength.

The at least one bandpass filter, which may have the optical filter layer, may be a dielectric interference filter having a layer sequence comprising at least two materials, a first material having a high refractive index and a second material having a low refractive index. The first material having a high refractive index is preferably one of the materials titanium oxide (TiO₂), silicon nitride (Si₃N₄), hafnium oxide (HfO₂), zirconium oxide (ZrO₂), aluminum oxide (Al₂O₃), polysilicon (polycrystalline silicon) or indium tin oxide (ITO). However, the first material may also be silicon dioxide (SiO₂). Furthermore, the first material may be any desired mixture of the abovementioned or other materials, in such a way that the first material has a suitable refractive index. The use of most of the abovementioned materials as first material for the dielectric interference filter has the advantage that the application of layers of the abovementioned materials can be realized by means of standardized CMOS processes. This advantageously affects the costs of the fluorescence biosensor chip, since it enables the fluorescence biosensor chip to be produced by means of standardized and mature methods. The second material of the dielectric interference filter having a low refractive index is preferably silicon dioxide (SiO₂), which is likewise compatible with CMOS processes and thus supports the cost-effective and, less complicated production of the fluorescence biosensor chip. However, the second material may also be one of the materials titanium oxide (TiO₂), silicon nitride (Si₃N₄), hafnium oxide (HfO₂), zirconium oxide (ZrO₂), aluminum oxide (Al₂O₃), polysilicon (polycrystalline silicon) or indium tin oxide (ITO). Furthermore, the second material may be any desired mixture of the aforementioned or other materials, in such a way that the second material has a suitable refractive index. It must be emphasized that the materials of the dielectric filter of the fluorescence biosensor chip according to the invention are not restricted to the aforementioned materials. Any other suitable material having a sufficiently high refractive index may be chosen for the first material having a high refractive index, and any other suitable material having a sufficiently low refractive index may be chosen for the second material having a low refractive index.

What is crucial for the functionality of the dielectric interference filter is that the dielectric interference filter is intended to be as far as possible opaque to light between a first limit wavelength and a second limit wavelength. In other words, the interference filter is intended to be set up in such a way that it has a transmission coefficient of ideally zero, realistically as close as possible to zero, for electromagnetic radiation having a wavelength above the lower limit wavelength and below the upper limit wavelength. By contrast, the dielectric interference filter is intended to be as transmissive as possible for electromagnetic radiation having a wavelength below the lower limit wavelength or above the upper limit wavelength, i.e. to have a transmission coefficient of ideally one, realistically as close as possible to one, for electromagnetic radiation of the aforementioned wavelength ranges. Furthermore, the dielectric interference filter is intended to have a large edge steepness, that is to say that the transmission coefficient is intended to fall from one to zero as abruptly as possible at the lower limit wavelength and to rise from zero to one as abruptly as possible at the upper limit wavelength.

The dielectric interference filter is preferably an arrangement comprising 31 layers with alternately a high and a low refractive index:

0.5H; L; (HL)¹⁴; 0.5H

In this case, the layer thicknesses are specified in quarters of optical wavelengths, i.e. in multiples and fractions of λ/4. The designation 0.5H designates a layer made of a material having a high refractive index (“H” for “high”), the thickness of which layer corresponds to half a quarter wavelength of the radiated-in light in the traversing medium. 0.5H accordingly designates a λ/8 layer made of the material having a high refractive index, where λ is the quotient of the wavelength of light in a vacuum and the refractive index of the medium. The λ/8 layer of the material having a high refractive index is followed by a λ/4 layer of the material having a low refractive index (“L” for “low”). This is followed by 14 λ/4 double layers comprising alternately the material having a high refractive index and the material having a low refractive index. The layer arrangement is again terminated by a λ/8 layer made of the material having a high refractive index. The layer system described is constructed from alternating layers of silicon dioxide material (low refractive index) and silicon nitride material (high refractive index).

By setting the layer thicknesses, it is possible to define the wavelength of the reflection maximum at a defined angle of incidence of the light. In accordance with the above-described preferred exemplary embodiment of the dielectric interference filter comprising 31 layers of silicon dioxide/silicon nitride, more than 99% of light is reflected in a wavelength range of between approximately 350 nanometers and approximately 390 nanometers.

As described above, the optical filter layer of the fluorescence biosensor chip of the invention may also have at least one cut-off filter. The cut-off filter is preferably a color filter produced from an organic material. Such color filters made of organic materials have a wavelength-dependent absorption coefficient. Although such color filters made of organic materials often do not have steep filter edges, as are necessary for a large dynamic range, such filters have the advantageous property of often not having a strong degree of ripple, i.e. of not having oscillatory features in the absorption coefficient/wavelength characteristic curve. Therefore, the use of cut-off filters is particularly advantageous according to the invention if a cut-off filters is combined with a bandpass filter.

The suitable combination of at least one bandpass filter and/or at least one cut-off filter enables the absorption properties of the optical filter layer of the fluorescence biosensor chip of the invention to be set flexibly to the requirements of the individual case. For applications in which a moderate detection sensitivity is sufficient, the optical filter layer may be configured simply. As an alternative to this, the optical filter layer may be configured to enable an optimized detection sensitivity of the fluorescence biosensor chip for example in particular wavelength ranges. Therefore, a desired balance between cost-effectiveness and detection accuracy can be achieved by means of the invention's configuration of the optical filter layer.

The fluorescence biosensor chip preferably furthermore has a circuit layer between the substrate and the optical filter layer, at least one electrical component being integrated into the circuit layer and the circuit layer being electrically coupled to the at least one detection device.

The fact that the circuit layer is arranged between the substrate and the optical filter layer makes it possible to produce the fluorescence biosensor chip with the circuit layer according to a standardized CMOS process. This contributes to the cost-effectiveness of the fluorescence biosensor chip. The circuit layer essentially serves for electrically reading out a hybridization event on the immobilization layer, which event is detected by the detection devices. If a hybridization event takes place on the immobilization layer and if the hybridized molecules to be detected emit an electromagnetic fluorescence signal in the direction of the photodiodes, then a charge separation takes place in the photodiodes, and can be read out electrically by means of the electronic components of the circuit layer.

In particular, the at least one detection device can be electrically driven by means of the circuit layer. In other words, each individual photodiode can be read in respect of whether an electrical signal is present at it on account of a hybridization event on the immobilization layer.

The immobilization layer of the fluorescence biosensor chip has, by way of example, one or a combination of the materials silicon dioxide, silicon nitride, organic material and/or gold.

Furthermore, in accordance with the fluorescence biosensor chip according to the invention, a multiplicity of capture molecules may be coupled to the immobilization layer, the capture molecules being set up in such a way that a molecule which is to be detected and is complementary to the capture molecule can be coupled to the capture molecules that are ready for binding. In particular, the number of molecules to be detected may be greater than the number of capture molecules immobilized on the immobilization layer of a fluorescence biosensor chip. If each of the capture molecules of a fluorescence biosensor chip has hybridized with a molecule to be detected, the fluorescence biosensor chip is at “saturation”, i.e. it has no more capture molecules ready for binding, so that nonhybridized molecules to be detected may, if appropriate, hybridize with other capture molecules at fluorescence biosensor chips not in the saturation state (e.g. in the case of an arrangement of a plurality of fluorescence biosensor chips). The capture molecules may be, in particular, nucleic acids (DNA or RNA), peptides, polypeptides, proteins or low-molecular-weight compounds. In chemistry, low-molecular-weight compounds are understood to be compounds having molecular masses or less than 1700 Daltons (molecular mass in grams per mol). The material or materials from which the immobilization layer is or are produced is or are coordinated with the capture molecules to be coupled. The capture molecules are immobilized at the surface of the immobilization layer by means of the microdispensing technique. In this case, bonds form automatically (“self assembly” technique) between the material of the immobilization layer and such end groups of the capture molecules which bind chemically with the material of the immobilization layer. The material pair gold/sulfur has particularly advantageous properties in this regard, so that the binding of sulfur-containing groups (for example thiol end groups) of capture molecules with immobilization layers produced from gold material may be cited as a particularly advantageous combination.

The capture molecules are highly selectively sensitive to very particular molecules which are to be detected and are complementary to the capture molecules. In other words, only very particular, structurally matching molecules to be detected are taken up by a particular capture molecule. Thus, if different capture molecules are provided on the surface of the immobilization layer, then a parallel analysis of different substances to be detected is possible. The parallel analysis of different substances to be detected, for example of different DNA half strands or of different proteins, has a time-saving effect and is of interest particularly for “high throughput screening” analyses. Thus, the analysis of a solution of an unknown composition may ideally be realized in a single analysis step using the fluorescence biosensor chip according to the invention. Such a highly parallel analysis has a time-saving effect.

Those capture molecules which are immobilized on the surface of the immobilization layer and are essentially arranged above one of the detection devices may serve as sensors associated with said detection device. When using the fluorescence biosensor chip according to the invention, the problem now arises that not only the light to be detected from the molecules to be detected which are hybridized with the capture molecules is incident on the detection devices. Rather, scattered light from the surroundings or primary light provided for the excitation of fluorescence markers is also incident on the detection devices. This parasitic electromagnetic radiation corrupts the signal of the detection devices. Therefore, it is desirable to quantitatively detect the strength of this noise signal (or background signal) and subtract it from the detected signals. This can be realized according to the invention by virtue of the fact that a surface section of the immobilization layer is free of capture molecules so that a noise signal can be tapped off at the at least one detection device arranged below said surface section.

The fact that the noise signal is subtracted from the signals of all the other detection devices means that, from the other signals, the contribution of parasitic scattered light can be separated from the fluorescence light to be detected, thereby increasing the detection sensitivity of the fluorescence biosensor chip. The noise signal (also called background or background signal) can also be measured simultaneously by a plurality of detection devices, which further increases the detection sensitivity.

Preferably, the molecules to be detected and/or the capture molecules have a fluorescence marker, the fluorescence marker being set up in such a way that it absorbs electromagnetic radiation of a third wavelength range and, after absorption has been effected, emits electromagnetic radiation of a fourth wavelength range, at least part of the third wavelength range lying outside the fourth wavelength range, at least part of the fourth wavelength range lying within the first wavelength range.

The functionality of the fluorescence biosensor chip of the invention is described clearly below. If no molecules to be detected with fluorescence markers are attached to the capture molecules at the surface of the fluorescence biosensor chip then light that is radiated in externally passes through the capture molecules and the immobilization layer essentially unattenuated. However, the light that is radiated in is reflected by an appropriately chosen filter layer and therefore does not pass as far as the photodiodes integrated into the substrate.

If, by contrast, the surface of the fluorescence biosensor chip is brought into contact with a solution containing molecules to be detected, then molecules to be detected can hybridize with the capture molecules arranged on the immobilization layer of the fluorescence biosensor clip if the capture molecules and the molecules to be detected match according to the key-lock principle. The hybridized molecules to be detected are provided with a suitable fluorescence marker. As an alternative, the the capture molecules may also be provided with a fluorescence marker. Fluorescence markers are molecular groups which absorb electromagnetic radiation of a specific wavelength range (referred to above as the third wavelength range) and, after absorption has been effected, emit electromagnetic radiation of a different wavelength range (called fourth wavelength range above). The fluorescence markers reemit electromagnetic radiation with increased wavelengths in comparison with the light that is radiated in. Fluorescence markers are coupled to molecules to be detected usually by means of so-called linker molecules, that is to say molecules which couple the molecule to be detected to the fluorescence marker (or the capture molecule). If molecules to be detected with fluorescence markers coupled thereto hybridize to capture molecules immobilized at the surface of the immobilization layer, then the fluorescence markers are situated spatially near to the immobilization layer. If light of a suitable wavelength range is radiated in externally, then this electromagnetic radiation can be absorbed by the fluorescence markers provided that the electromagnetic radiation has at least a wavelength within the third wavelength range, within which the fluorescence markers can absorb electromagnetic radiation. As a result, the fluorescence markers are put into an electronic excitation state characterized by an average lifetime. On average according to this average lifetime, the fluorescence markers reemit electromagnetic radiation of a fourth wavelength range, the fourth wavelength range having longer-wave more electromagnetic radiation than the third wavelength range. In other words, the light reemitted by the fluorescence markers has a longer wavelength than the incident light. However, the intensity of the reemitted light is typically a plurality of orders of magnitude lower than the intensity of the incident light provided for example by an external radiation source. The fluorescence light of the fourth wavelength range and the nonabsorbed externally incident light pass through the immobilization layer and reach the optical filter layer. As described above, the optical filter layer is set up in such a way that the optical filter layer totally reflects electromagnetic radiation of a second wavelength range, at least part of the first wavelength range in which the detection devices can detect electromagnetic radiation lying outside the second wavelength range. The second wavelength range, in which the optical filter layer effects total reflection, is set up according to the invention in such a way that the externally incident light is essentially reflected and that the light of the fourth wavelength range which is reemitted by the fluorescence markers is essentially transmitted through the optical filter layer. As a result, essentially only the fluorescence light of weak intensity passes through the filter layer, whereas the external light of strong intensity, which served for exciting the fluorescence markers, is reflected. The electromagnetic radiation of the fourth wavelength range which is emitted by a fluorescence marker situated at a particular capture molecule penetrates through the optical filter layer and, after passing through the essentially transparent circuit layer, ideally passes to that photodiode in the substrate which is at the least distance from the emitting fluorescence marker. The photodiode, which is set up in such a way that electromagnetic radiation of a first wavelength range can be detected thereby, is suitable for detecting the electromagnetic fluorescence radiation of the fourth wavelength range since the fluorescence biosensor chip according to the invention is set up in such a way that at least part of the fourth wavelength range lies within the first wavelength range. As a result, the photodiode is suitable for detecting the fluorescence radiation and is thus suitable for indirectly detecting a hybridization event on a capture molecule arranged thereabove.

As an alternative, hybridization events may be detected by detecting fluorescence radiation in that, after the docking of molecules to be detected to capture molecules having fluorescence markers, the sensor plane is brought into operative contact with a substance set up in such a way that, by means of said substance, capture molecules having fluorescence markers without docked molecules to be detected are stripped from the sensor plane whereas capture molecules with molecules to be detected which are docked thereto also remain docked at the sensor plane in the presence of the substance. Once capture molecules having fluorescence markers without molecules to be detected which are hybridized therewith have been stripped away, only those capture molecules having fluorescence markers to which molecules to be detected are docked remain at the sensor plane. These hybridization events can then be detected in accordance with the above-described principle by detection of the fluorescence radiation of the fluorescence markers coupled to the capture molecules. In accordance with the alternative concept described, it is not necessary to bind fluorescence markers to molecules to be detected; it is possible instead to bind the fluorescence markers to the capture molecules.

In accordance with a further alternative concept, fluorescence markers may be added only after the hybridization events. If the fluorescence markers are set up in such a way that they bind only to capture molecules with molecules to be detected which are hybridized thereto (e.g. bind only to double-stranded DNA), then the intensity of the electromagnetic radiation emitted by the fluorescence markers is characteristic of the number of hybridization events effected.

According to the invention, it is also possible to use different fluorescence markers in order to detect different molecules with different fluorescence markers. This enables a parallel analysis by means of which the different components of an analyte can be simultaneously examined and quantified.

By way of example, coumarin (1,2-benzpyrone 2H-1-benzpyran-2-one, C₉H₆O₂) is used as a fluorescence marker. The fluorescent dye coumarin has the property, given excitation with electromagnetic radiation having the wavelength 370 nanometers, of reemitting electromagnetic fluorescence radiation in a wavelength range of around approximately 460 nanometers. The fluorescence marker coumarin thus ensures a sufficiently intense red shift off the reemitted electromagnetic radiation, so that exciting and emitted electromagnetic radiation can be readily separated from one another. Any other suitable material, such as, by way of example, FITC, Cy2, Alexa Fluor 488, BODIPY 493, Rhodamine 123, R6G, TET, JOE, HEX, BODIPY 530, Alexa 532, R-phycoerythrin, TRITC, Cy3, TAMRA, Texas Red, ROX, BODIPY 630 and Cy5, may also be used as a fluorescence marker.

The surface of the fluorescence biosensor chip preferably has a matrix-like arrangement of individual sensor arrays. As discussed above, each individual sensor array call be read individually by means of the circuit layer. In order to increase the integration density of the sensor arrays, the sensor arrays are arranged as densely as possible. This is advantageous for “high throughput screening” applications. On the other hand, the dense arrangement of sensor arrays is associated with the risk that optical crosstalk from one sensor array to an adjacent sensor array may occur. The photodiodes integrated in the substrate image the immobilization layer with the capture molecules immobilized thereon in a positionally correct manner. As a result, a photodiode is essentially sensitive to the fluorescence radiation of those capture molecules which are essentially arranged above the photodiode. Optical crosstalk is understood, then, to mean that electromagnetic fluorescence radiation of a fluorescence marker is not radiated onto the essentially underlying photodiode, but rather is emitted for example in the direction of another photodiode arranged on the left or right beside the former photodiode. As a result, there is the risk of a hybridization event at a capture molecule being erroneously detected by a photodiode which is not arranged below the capture molecule. One advantage of the invention is that possibilities are afforded, according to the invention, of keeping down or preventing optical crosstalk between adjacent sensor arrays. This results in the advantageous effect that a high integration density of sensors on the fluorescence biosensor chip is combined with reduced optical crosstalk.

In order to achieve this aim, preferably, at least one isolation, trench for optically isolating adjacent detection devices is introduced into at least one surface region of the fluorescence biosensor chip, which at least one isolation trench extends through the immobilization layer right into a region of the optical filter layer, in such a way that a detection device is in each case arranged below each region between two adjacent isolation trenches. Preferably, at least part of the surface of the at least one isolation trench is covered with a layer made of an absorbent material, or at least one of the trenches is filled with an absorbent material, the absorbent material being set up in such a way that it absorbs or reflects electromagnetic radiation at least of the respective wavelength range or of the respective wavelength ranges.

If, as described above, a fluorescence marker arranged essentially above a first photodiode relative to the direction of light incidence emits fluorescence radiation in a direction in which, rather than the photodiode located underneath, a photodiode adjacent thereto is arranged, then a trench which is introduced in a suitable manner between the photodiodes and is at least partly filled with a material that absorbs electromagnetic radiation can prevent the electromagnetic fluorescence radiation from being detected by an “incorrect” photodiode. Instead of an incorrect detection, the fluorescence radiation is absorbed by the absorbent material in the trench.

This reduces the risk of optical crosstalk. This is advantageous since this increases the detection sensitivity of the fluorescence biosensor chip and reduces the susceptibility of the fluorescence biosensor chip to errors.

Optical crosstalk may be reduced further in that a barrier layer made of an absorbent material is provided in at least one region of the circuit layer, in such a way that a detection device is in each case arranged below each region between two adjacent barrier layers, the absorbent material being set up in such a way that it absorbs or reflects electromagnetic radiation at least of the respective wavelength range or of the respective wavelength ranges.

As described above, the isolation trench is introduced, for example etched, into the immobilization layer and at least partly into the optical filter layer. Fluorescence radiation which is reemitted by a fluorescence marker at an angle such that the fluorescence radiation, on its way to a photodiode arranged on the left or right of that below the fluorescence marker, does not pass through the isolation trench but rather runs below the isolation trench through the circuit layer may be detected by an “incorrect” photodiode despite the isolation trench. The risk of optical crosstalk is thus reduced, but not necessarily completely precluded, by means of the isolation trenches.

In order to further reduce optical crosstalk, it is possible, as described above, to introduce barrier layers made of absorbent material into the circuit layer. Said barrier layers have essentially the same function as the absorbent material in the isolation trenches, namely of absorbing and/or reflecting fluorescence radiation on the way to an “incorrect” photodiode. However, the barrier layer implements this functionality in the circuit layer, whereas the isolation trenches implement this functionality in the immobilization layer and in the optical filter layer. The barrier layers preferably fulfill a dual function in the circuit layer. On the one hand—as described above—optical crosstalk is prevented by means of the barrier layers; on the other hand, the absorbent and/or reflective barrier layers, provided that they are produced from an electrically conductive material, can also implement the function of electronic components in the circuit layer. Thus, by way of example, the barrier layers may serve as electrical leads to the photodiodes in the substrate. The barrier layers are preferably metallic interconnects or passage holes which are introduced into the circuit layer and are filled with an electrically conductive material that absorbs/reflects electromagnetic radiation. The barrier layers further reduce optical crosstalk between adjacent sensor arrays, thereby increasing the detection sensitivity. The dual function of the barrier layer according to the invention as means for reducing optical crosstalk, on the one hand, and as electrically integrated components, on the other hand, is economical and space-saving.

The invention furthermore provides a fluorescence biosensor chip arrangement having a fluorescence biosensor chip and an electromagnetic radiation source. The fluorescence biosensor chip has a substrate, at least one detection device arranged in or on the substrate and serving for detecting electromagnetic radiation of a first wavelength range, an optical filter layer arranged on the substrate and serving for absorbing and/or reflecting electromagnetic radiation of a second wavelength range, an immobilization layer arranged on the optical filter layer and serving for immobilizing capture molecules, the detection device, the filter layer and the immobilization layer being integrated in the fluorescence biosensor chip. The electromagnetic radiation source is set up in such a way that a surface region of the fluorescence biosensor chip can be irradiated with electromagnetic radiation of a third wavelength range by means of the electromagnetic radiation source.

It must be emphasized that all those refinements which have been described further above with reference to the fluorescence biosensor chip according to the invention also apply to the fluorescence biosensor chip arrangement according to the invention.

The fluorescence biosensor chip arrangement of the invention essentially has an electromagnetic radiation source in addition to the fluorescence biosensor chip according to the invention. The electromagnetic radiation source is provided for irradiating the surface region of the fluorescence biosensor chip with electromagnetic radiation of a third wavelength range. The electromagnetic radiation source is preferably a laser, a light-emitting diode, a gas discharge lamp or an incandescent lamp. If the electromagnetic radiation source is configured as a laser, then this enables the surface of the fluorescence biosensor chip to be irradiated with monochromatic, narrowband light. Monochromatic light can readily be filtered away by means of a filter layer whose optical absorption properties are wavelength-dependent.

The fluorescence biosensor chip arrangement furthermore has a multiplicity of capture molecules which are coupled to the immobilization layer and are set up in such a way that a molecule to be detected which is complementary to the capture molecule can be coupled to the capture molecules. The capture molecules are coupled to the immobilization layer in the manner that has been described further above with reference to the fluorescence biosensor chip.

Each molecule to be detected furthermore has a fluorescence marker, the fluorescence marker being set up in such a way that it at least partly absorbs electromagnetic radiation of the third wavelength range and, after absorption has been effected, emits electromagnetic radiation of a fourth wavelength range, at least part of the third wavelength range lying outside the fourth wavelength range, and at least part of the fourth wavelength range lying within the first wavelength range. Furthermore, at least part of the first wavelength range lies outside the second wavelength range.

The functionality of the fluorescence biosensor chip arrangement according to the invention is described in more detail below. The surface of the fluorescence biosensor chip arrangement is irradiated with electromagnetic radiation of the third wavelength range by means of the electromagnetic radiation source. The immobilization layer, at which capture molecules are immobilized, is situated at the surface of the fluorescence biosensor chip arrangement of the invention. A solution with molecules to be detected is brought into operative contact with this active sensor surface. If molecules to be detected which are situated in this solution are sufficiently complementary with capture molecules immobilized on the immobilization layer, then the molecules to be detected hybridize with the capture molecules. The molecules to be detected are coupled to a fluorescence marker by means of a linker molecule, by way of example, the fluorescence marker being set up in such a way that it at least partially absorbs electromagnetic radiation of the third wavelength range. Therefore, after the hybridization of the molecules to be detected to the capture molecules, the light emitted by the electromagnetic radiation source is absorbed by the fluorescence markers at the molecules to be detected. The fluorescence markers are set up in such a way that, after the absorption of electromagnetic radiation of the third wavelength range, the fluorescence markers emit electromagnetic radiation of a fourth wavelength range, at least part of the third wavelength range tying outside the fourth wavelength range. This means that the fluorescence radiation of the fluorescence markers has a longer wavelength than the previously absorbed radiation of the third wavelength range provided by the electromagnetic radiation source. The primary radiation in the third wavelength range and the fluorescence radiation in the fourth wavelength range penetrate through the immobilization layer and then pass to the optical filter layer. The optical filter layer is set up in such a way that electromagnetic radiation of the second wavelength range is absorbed and/or reflected by means of the optical filter layer. Ideally, the optical filter layer completely reflects or absorbs the electromagnetic radiation of the third wavelength range, which originates from the external electromagnetic radiation source. By contrast, the optical filter layer ideally completely transmits the electromagnetic radiation of the fourth wavelength range, which originates from the fluorescence markers. In other words, the optical filter layer is set up in such a way that it is completely transmissive to the fluorescence light, whereas it is completely opaque to the light from the electromagnetic radiation source.

As a result, ideally exclusively the fluorescence radiation passes to the detection devices integrated in the substrate and serving for detecting electromagnetic radiation of the first wavelength range. According to the invention, at least part of the fourth wavelength range, within which the fluorescence radiation of the fluorescence markers lies, lies within the first wavelength range, within which the detection devices are able to detect electromagnetic radiation. As a result, the hybridization of molecules to be detected together with fluorescence molecules with capture molecules bound to the surface of the immobilization layer can be detected by means of an electrical signal at the photodiodes integrated in the substrate. In this case, suitable setting of the wavelength ranges involved is accorded a crucial importance.

A description is given below of refinements of the fluorescence biosensor chip arrangement of the invention which make it possible to increase the detection sensitivity of the fluorescence biosensor chip arrangement.

Preferably, the electromagnetic radiation source can be oriented in such a way that the electromagnetic radiation emitted by the electromagnetic radiation source at a predeterminable angle with respect to the direction of the normal to the optical filter layer.

Clearly, the direction from which the electromagnetic radiation of the electromagnetic radiation source is incident on the capture molecules is predeterminable, for example by using an electromagnetic radiation source which generates a beam of parallel light rays, and by said electromagnetic radiation source being set up in displaceable, rotatable, pivotable or tiltable fashion. By means of an oblique incidence of the exciting light on the fluorescence markers, that part of the exciting light which is transmitted through the optical filter does not impinge directly on that photodiode which is essentially arranged below the absorbent and emitting fluorescence marker. In other words, the disturbing primary light which reduces the detection sensitivity of the fluorescence biosensor chip arrangement is partly “geometrically” shielded. In order to prevent the obliquely incident exciting light from manifesting disadvantageous effects in adjacent photodiodes, the obliquely incident exciting light may, if appropriate, be shielded from detection by means of isolation trenches and/or barrier layers, as described above.

By utilizing the oblique incidence of the electromagnetic radiation of the electromagnetic radiation source, shadow effects may advantageously be utilized in order to increase the detection sensitivity of the fluorescence biosensor chip arrangement.

In accordance with another refinement of the invention, the electromagnetic radiation source is set up in such a way that the electromagnetic radiation emitted by the electromagnetic radiation source is emitted in pulses, and in which the detection devices are set up in such a way that the electromagnetic radiation emitted by the fluorescence markers can be detected in the time intervals between the pulses by means of the detection devices.

This utilizes the physical effect that the excited electron state of the fluorescence marker, after absorbing the exciting light, has a finite lifetime that differs from zero. If a short pulse of exciting light is radiated onto the fluorescence markers by means of the electromagnetic radiation source, then the fluorescence markers are put into an excited electron state by means of light absorption. The incident light which is not absorbed by the fluorescence markers reaches the detector devices virtually instantaneously on account of the high speed of light, the signal of which detector devices is not detected at this point in time. In other words, the detection devices are switched off during the pulse. After a time interval which essentially corresponds to the average lifetime of the excited electron state of the fluorescence marker, a time-delayed electromagnetic fluorescence wave is radiated by the fluorescence markers. The time delay is of the order of magnitude of the natural lifetime of excited electron states (approximately microseconds to nanoseconds). If the measurement signal of the detection devices is not recorded until after this time delay, then the parasitic detection of exciting light is avoided and only fluorescence radiation is detected. For this purpose, detection devices with a sufficiently good temporal resolution are preferably to be chosen, for example photodiodes which have a temporal resolution in the sub-nanoseconds range. Suppressing the detection of the primary light increases the detection sensitivity of the fluorescence biosensor chip arrangement of the invention.

Exemplary embodiments of the invention are illustrated in the figures and are explained in more detail below.

### BRIEF DESCRIPTION OF THE DRAWINGS

FIG. 1A shows a schematic view of one fluorescence biosensor chip in accordance with the prior art,

FIG. 1B shows an exploded illustration of another fluorescence biosensor chip in accordance with the prior art,

FIG. 2 shows a cross-sectional view of a fluorescence biosensor chip in accordance with a first exemplary embodiment of the invention,

FIG. 3 shows a cross-sectional view of a fluorescence biosensor chip in accordance with a second exemplary embodiment of the invention,

FIG. 4 shows a diagram which schematically shows the dependence of the transmission on the wavelength of a dielectric interference filter in accordance with a preferred exemplary embodiment of the optical filter layer according to the invention,

FIG. 5A shows a plan view of a fluorescence biosensor chip in accordance with a third exemplary embodiment of the invention,

FIG. 5B shows an enlarged partial cross-sectional view along the section line I-I′ from FIG. 5A in accordance with the third preferred exemplary embodiment of the fluorescence biosensor chip of the invention,

FIG. 6A shows a circuit diagram with a drive logic for driving a sensor array in accordance with a preferred exemplary embodiment of the fluorescence biosensor chip of the invention,

FIG. 6B shows an enlarged view of the drive logic for driving a sensor array in accordance with the preferred exemplary embodiment of the fluorescence biosensor chip of the invention,

FIG. 7 shows a cross-sectional view of a fluorescence biosensor chip arrangement in accordance with a preferred exemplary embodiment of the invention.

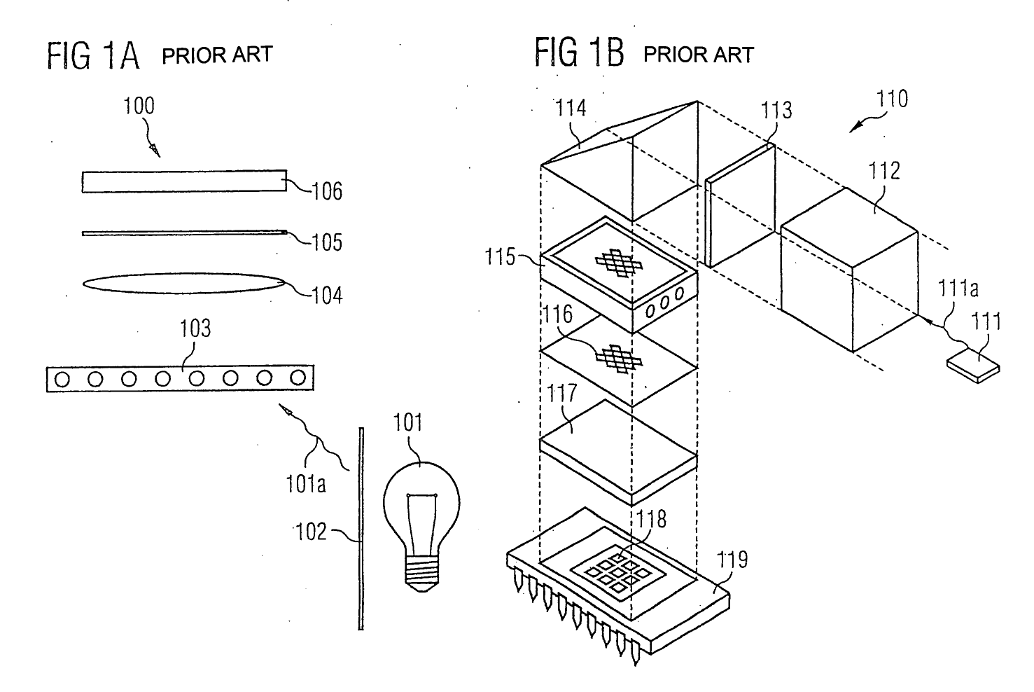

### DETAILED DESCRIPTION OF THE PREFERRED MODE OF THE INVENTION

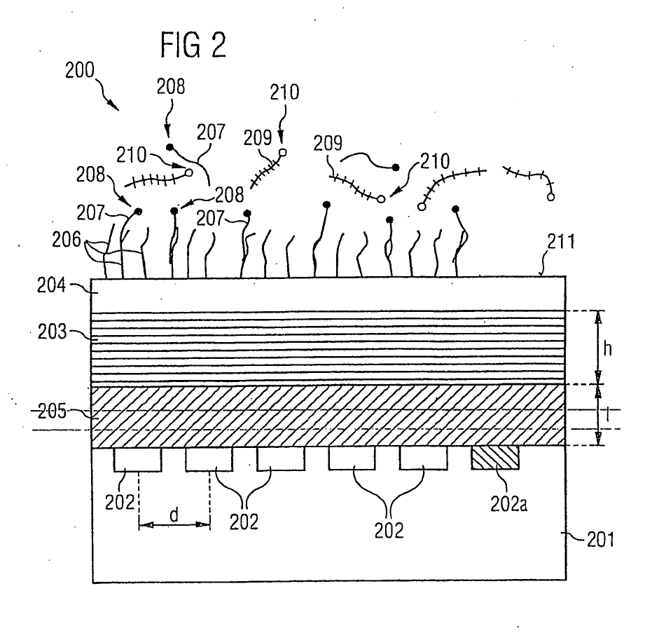

The fluorescence biosensor chip 100 in accordance with a first exemplary embodiment of the invention is described below with reference to FIG. 2.

The fluorescence biosensor chip 200 has a substrate 201, at least one detection device 202 arranged in or on the substrate 201 and serving for detecting electromagnetic radiation, an optical filter layer 203 arranged on the substrate 201, and an immobilization layer 204 arranged on the optical filter layer 203 and serving for immobilizing capture molecules. The detection devices 202, the filter layer 203 and the immobilization layer 204 are integrated in the fluorescence biosensor chip 200, as shown in FIG. 2.

In accordance with the exemplary embodiment of the fluorescence biosensor chip 200 according to the invention as shown in FIG. 2, the substrate 201 is produced from silicon material. Furthermore, six detection devices 202 are provided, each of the six detection devices 202 being formed as a photodiode which are set up in such a way that electromagnetic radiation of a first wavelength range can be detected thereby. As shown in FIG. 2, adjacent detection devices 202 are provided at a distance “d” from one another. The distance “d”, which is equal to 200 micrometers in accordance with the exemplary embodiment shown in FIG. 2, is a measure of the pixel size of a sensor array on the surface of the fluorescence biosensor chip. In other words, all those capture molecules which can be immobilized on the surface of the immobilization layer 204 and are at a smaller distance from a particular detection device 202 than from all the other sensor devices 202 belong to a sensor pixel. The distance “d” is therefore a measure of the one-dimensional spatial resolution of the fluorescence biosensor chip 200 according to the invention. In other words, d² is a measure of the two-dimensional spatial resolution of the fluorescence biosensor chip 200 according to the invention, i.e. for the required surface area of the fluorescence biosensor chip 200 per sensor pixel.

The optical filter layer 203 is set up in such a way that the optical filter layer 203 absorbs electromagnetic radiation of a second wavelength range, at least part of the first wavelength range lying outside the second wavelength range.

In accordance with the exemplary embodiment shown in FIG. 2, the optical filter layer 203 is configured as a cut-off filter. The cut-off filter 203 of the fluorescence biosensor chip 200 absorbs electromagnetic radiation below a limit wavelength. The optical cut-off filter 203 is a color filter produced from an organic material.

As shown in FIG. 2, the optical filter layer 203 has a thickness “h”, which is of the order of magnitude of 70 micrometers in accordance with the exemplary embodiment described. The thickness “h” of the optical filter layer 203 configured as an organic cut-off filter is to be chosen to be large enough to as far as possible completely absorb such electromagnetic radiation which is not intended to pass to the detection devices 202, and the optical filter layer 203 configured as an organic cut-off filter is to be chosen to be thin enough to transmit to a sufficient extent such electromagnetic radiation which is intended to pass to the detection devices 202 in order to be detected by the detection devices 202.

The immobilization layer 204 shown in FIG. 2 is a thin gold layer in accordance with the exemplary embodiment described.

The fluorescence biosensor chip 200 furthermore has a circuit layer 205 between the substrate 201 and the optical filter layer 203, at least one electrical component being integrated into the circuit layer 205, and the circuit layer 205 being electrically coupled to the at least one detection device 202.

The electrical components integrated in the circuit layer 205 are not shown in FIG. 2. The circuit layer 205 is set up in such a way that the detection devices 202 can be electrically driven in each case individually by means of the circuit layer 205. An exemplary embodiment of a suitable electrical drive circuit is described further below. In accordance with the fluorescence biosensor chip 200 shown in FIG. 2, the circuit layer 205 has MOS transistors for selecting one of the detection devices 202, electrically conductive connections for coupling the detection device 202 to a drive circuit, and further electronic components which serve for amplifying and evaluating the measurement signal. These electrical components are integrated into the circuit layer 205. As shown in FIG. 2, the circuit layer 205 has a thickness “l”, which is approximately five micrometers in accordance with the exemplary embodiment described. The thickness “l” should be chosen to be small enough, or the materials should be chosen suitably, that losses on account of absorption of electromagnetic radiation to be detected in the circuit layer 205 are small.

The fluorescence biosensor chip 200 furthermore contains a multiplicity of capture molecules 206, which are coupled to the immobilization layer 204 and are set up in such a way that a molecule 207 to be detected which is complementary to the capture molecule 206 can be coupled to each of the capture molecules 206 that are ready for binding. The capture molecules 206 shown in FIG. 2 are DNA half strands. Each molecule 207 to be detected has a fluorescence marker 208.

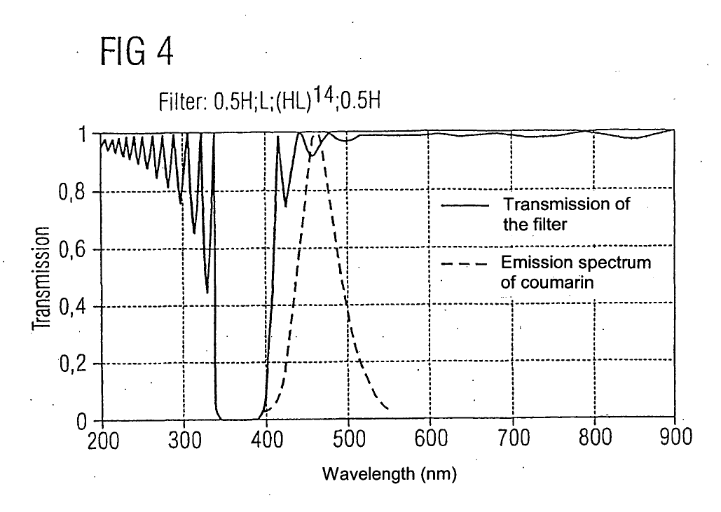

The fluorescence markers 208 are set up in such a way that the fluorescence markers 208 absorb electromagnetic radiation of a third wavelength range and, after absorption has been effected, emit electromagnetic radiation of a fourth wavelength range. The fluorescence marker 208 shown in FIG. 2 is coumarin. The diagram shown in FIG. 4 depicts the emission spectrum of coumarin after the fluorescence dye coumarin has been excited with electromagnetic radiation having a wavelength of 370 nanometers. A relatively broad absorption band with a maximum near 460 nanometers can be seen. In accordance with the exemplary embodiment described, this emission spectrum corresponds to the fourth wavelength range defined above.

As shown in FIG. 2, the surface region of the fluorescence biosensor chip 200 is not only in operative contact with molecules 207 to be detected which are coupled to a fluorescence marker 208. Furthermore, molecules 209 are also in operative contact with the capture molecules 206 on the surface of the immobilization layer 204. Said molecules 209 are likewise coupled to fluorescence markers 210, which, however, differ from the fluorescence markers 208 coupled to the molecules 207 to be detected to the effect that the fluorescence markers 210 absorb or fluoresce in different wavelength ranges than the fluorescence markers 208 of the molecules 207 to be detected. In contrast to the molecules 207 to be detected, which are complementary to the capture molecules 206 and are consequently attached to the capture molecules, the molecules 209 are not complementary to the capture molecules 206 and are therefore unable to hybridize with the capture molecules 206. This consideration shows that the detection of molecules by means of attachment to the capture molecules 206 is effected in a highly selective manner. If the molecules 210 were complementary to the capture molecules 206, then only the molecules 210 would hybridize with the capture molecules 206, whereas the molecules 208 to be detected would not hybridize with the capture molecules 206 in this alternative case. The decision as to whether the molecules 207 or the molecules 209 attach to the capture molecules 206 can be determined by means of analysis of the wavelength of the fluorescence light of the fluorescence markers 208 or 210.

The functionality of the fluorescence biosensor chip 200 is described below. The fluorescence biosensor chip 200 is brought into contact with a solution containing, inter alia, the molecules 207 to be detected with fluorescence markers 208 coupled thereto by means of linker molecules. Molecules 207 which are complementary to the capture molecules 206 hybridize with the capture molecules 206. If appropriate, a suitable rinsing or washing step is carried out. The hybridization event can be detected by radiating in electromagnetic radiation of the third wavelength range, in which the fluorescence markers 208 effect absorption.

After absorption has been effected, the fluorescence markers 208 reemit light of a fourth wavelength range, the reemitted light having a longer wavelength than the absorbed light. Both the light that is radiated in and the fluorescence light pass through the essentially transparent immobilization layer 204 and pass to the optical filter layer 203.

The optical filter layer 203 configured as an organic cut-off filter is embodied as a blocking filter for the exciting light wavelength (third wavelength range). In other words, the light having the wavelength radiated in is essentially completely absorbed by the optical filter layer 203, whereas the fluorescence light of the fourth wavelength range is transmitted essentially unattenuated through the optical filter layer 203.

After passing through the essentially transparent circuit layer 205, the fluorescence light preferably passes to that one of the photodiodes 202 which is essentially arranged below that fluorescence marker 208 which emitted the fluorescence light. The photodiodes 202 are set up in such a way that electromagnetic radiation of the first wavelength range can be detected thereby. By virtue of the fact that the fluorescence markers 208 are set up in such a way that at least part of the fourth wavelength range (that wavelength range within which the fluorescence radiation lies) lies within the first wavelength range, the photodiode 202 is capable of detecting the fluorescence light. As a result, on the one hand, a hybridization event is detected and, on the other hand, the intensity of the detected fluorescence light is a measure of the number of attached molecules, i.e. of the degree of complementarity of the capture molecules 206 and molecules 207 to be detected.

Light having the exciting wavelength does not pass through the optical filter layer 203 and therefore cannot be detected in the photodiodes 202. As a result, the invention enables the fluorescence light to be separated from the exciting light by means of the optical filter layer 203. Since photodiodes 202 have a very high dynamic range, a high detection sensitivity can be achieved in the fluorescence biosensor chip according to the invention. A high dynamic range is understood to mean that the detector can measure electromagnetic fluorescence radiation of a large intensity range.

The spatial resolution of the fluorescence biosensor chip 200 is not achieved by means of lens optics, which is the way of the prior art, but rather by means of electrical selection of a sensor region on the immobilization layer 204, which is essentially arranged above a particular photodiode 202.

As shown in FIG. 2, a surface section 211 of the immobilization layer 204 is free of capture molecules 206 so that a noise signal can be tapped off at the at least one reference detection device 202a arranged below said surface section 211. Since no capture molecules are immobilized on the surface of the immobilization layer 204 above the reference detection device 202a, it is also the case that no molecules 207 to be detected can be attached in this surface section 211, so that no fluorescence markers 208 are arranged in this surface detection 211. Therefore, no fluorescence radiation passes to the reference section device 202a. With regard to the parasitic electromagnetic radiation (for example exciting light or scattered light from the surroundings) which is incident on the detection devices 202, 202a, what applies to the reference detection device 202a is the same as what applies to the detection devices 202. Therefore, at the reference detection device 202a, it is possible to tap off that noise signal or background signal or zero signal which stems from the parasitic electromagnetic radiation, and which is to be subtracted from the signals of all the other detection devices 202 in order to obtain a signal which is proportional to the intensity of the fluorescence light. This subtraction is carried out by means of an electronic differential circuit.

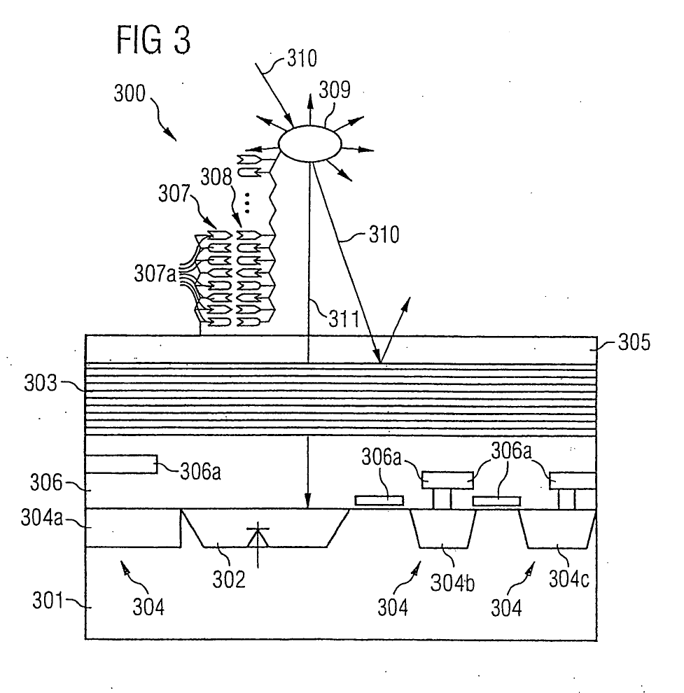

A fluorescence biosensor chip 300 in accordance with a second exemplary embodiment of the invention is described with reference to FIG. 3.

The fluorescence biosensor chip 300 has a substrate 301, a detection device 302 arranged in the substrate and serving for detecting electromagnetic radiation, an optical filter layer 303 arranged on the substrate 301, and an immobilization layer 304 arranged on the optical filter layer 303 and serving for immobilizing capture molecules. The detection device 302, the filter layer 303 and the immobilization layer 304 are integrated in the fluorescence biosensor chip 300.

The functionality of the fluorescence biosensor chip 300 largely corresponds to that of the fluorescence biosensor chip 200 described above with reference to FIG. 2. Therefore, only those features which, in the fluorescence biosensor chip arrangement 300, are configured differently from the fluorescence biosensor chip arrangement 200 are discussed at this juncture.

Thus, differently from the optical filter layer 203 shown in FIG. 2, the optical filter layer 303 is formed as a bandpass filter. The precise construction of the optical filter layer 303 is described further below with reference to FIG. 4.

As shown in FIG. 3, the detection device 302 is formed as a photodiode 302 integrated into the substrate 301. As shown in FIG. 3, further integrated circuit elements 304 are introduced into the substrate 301. The silicon dioxide region 304a serves for electrically insulating adjacent photodiodes 302. The n-doped silicon regions 304b, 304c are part of the drive electronics which can be used to drive a particular photodiode 302. The substrate 301 is a p-doped silicon substrate.

Furthermore, a circuit layer 306 is arranged between the substrate 301 and the optical filter layer 303, at least one electrical component 306a being integrated into the circuit layer 306, and the circuit layer 306 being electrically coupled to the detection device 302.

As shown in FIG. 3, the integrated circuit elements 306a, together with the n-doped silicon regions 304b, 304c and the p-doped silicon substrate 301, form a transistor-like arrangement, it being possible for the detection device 302 to be driven electrically by means of this transistor-like an arrangement.

A multiplicity of capture molecules are immobilized on the immobilization layer 305, only one capture molecule 307 thereof being depicted in FIG. 3 for reasons of simplicity. The capture molecule 307 shown in FIG. 3 is a DNA half strand, the bases 307a of which are depicted schematically in FIG. 3.

A molecule 308 to be detected which is complementary to the capture molecule 307 is coupled to the capture molecule 307. The molecule 308 to be detected has a fluorescence marker 309. The capture molecule 307 and the molecule 308 to be detected are two mutually complementary DNA half strands.

Referring once again to FIG. 3, the way in which a hybridization event can be detected by means of the fluorescence biosensor chip 300 is explained below.

Electromagnetic radiation of a third wavelength range 310, which is provided for example by an external electromagnetic radiation source (not shown in FIG. 3), impinges on the fluorescence marker 309 and is partly absorbed by the latter. The fluorescence marker 309 reemits electromagnetic fluorescence radiation of a fourth wavelength range 311, part of the emitted fluorescence radiation passing onto the fluorescence biosensor chip 300. The electromagnetic radiation of the fourth wavelength range 311 impinges on the filter layer 303, which is set up in such a way that the electromagnetic radiation of the fourth wavelength range 311 is at least partly transmitted through the filter layer 303. This part passes, as shown in FIG. 3, to the photodiode 302 and is detected there. The electromagnetic radiation of the fourth wavelength range 310 is for the most part reflected at the optical filter layer 303. As a result, ideally no electromagnetic radiation of the third wavelength range 310 passes onto the photodiode 302. Consequently, the invention realizes a situation in which exclusively fluorescence light to be detected of the fourth wavelength range 311 penetrates as far as the detection device 302, whereas the primary light of the third wavelength range 310 does not penetrate as far as the detection device 302.

The way in which the optical filter layer 303 is configured in accordance with a preferred exemplary embodiment is described below. The optical filter layer 303 is configured as a bandpass filter, which is a dielectric interference filter having a layer sequence comprising two materials, a first material having a high refractive index and a second material having a low refractive index. The first material having a high refractive index is silicon nitride, and the second material having a low refractive index is silicon dioxide. The dielectric interference filter in accordance with the preferred exemplary embodiment described has 31 alternating layers made alternatively of silicon dioxide and silicon nitride. The present dielectric interference filter is described by the following nomenclature:

0.5H; L; (HL)^{14;}0.5H

This nomenclature is to be read as follows:

“H” designates a layer made of the material having a high refractive index, silicon nitride in the example. “L” designates a layer made of the material having a low refractive index, silicon dioxide in the present case. The superscripted number 14 indicates that 14 alternating double layers made alternately of the layer having a high refractive index and the layer having an low refractive index are provided. The layer thicknesses are specified in multiples of λ/4 (λ: wavelength of light in the medium). λ/4 denotes a quarter of the wavelength of light in the medium, i.e. the quotient of the wavelength of light in the vacuum and the refractive index of the respective medium. In other words, the filter layer according to the invention has a λ/8 layer of the material having a high refractive index, a λ/4 layer of the material having a low refractive index, 14 double layers, each of the double layers being constructed from a λ/4 lamina of the material having a high refractive index and a λ/4 lamina of the material having a low refractive index, and also a λ/8 layer of the material having a high refractive index. An interference filter having a wavelength dependence of the transmission as is shown in FIG. 4 is obtained as a result. As shown in FIG. 4, a dielectric interference filter configured in this way reflects more than 99% of electromagnetic radiation in the wavelength range between 350 nanometers and 390 nanometers. In particular, the wavelength of the reflection maximum, i.e. of the transmission minimum in FIG. 4, given a defined angle of incidence of the electromagnetic radiation, can be set by means of adjustment of the layer thickness of the individual layers of the dielectric interference filter. Since the calculated transmission in dependence on the wavelength, as is illustrated in FIG. 4, has a pronounced transmission minimum in a relatively broad wavelength range between 350 nanometers and 390 nanometers, such a filter is also suitable for suppressing the exciting light of broadband excitation sources such as e.g. light-emitting diodes. If spectrally even broader light sources are intended to be used which, by way of example, also emit electromagnetic radiation at light wavelengths below the left-hand flank at 350 nanometers, then an additional filter is necessary in order to filter away electromagnetic radiation in the lower wavelength range. This can be realized for example by means of a suitable cut-off filter.

The diagram shown in FIG. 4 also depicts, as a broken line, the emission spectrum of coumarin as is obtained after excitation of the dye with electromagnetic radiation having a wavelength of 370 nanometers. Even though the emission spectrum of coumarin is relatively broadband in nature, the left-hand flank of the emission spectrum of coumarin is nonetheless a significantly longer wavelength than the right-hand limit of that wavelength range in which the optical filter described above approximately effects total reflection. The long-wave passband of the dielectric interference filter is to be configured as flat as possible, i.e. it is particularly expedient to ensure an approximately constant and highest possible transmission across the entire fluorescence range of the dye. This can be done by variation of the layer thickness of the dielectric filter layer and of the materials used therefor. The dielectric interference filter described is suitable for the fluorescence biosensor chip according to the invention if coumarin is used as a fluorescence marker. Referring once again to the FIG. 4 the transmission of the dielectric interference filter described is greater than 75% above about 415 nanometers and greater than 92% above 450 nanometers. As a result, the fluorescence light of the dye coumarin is attenuated only little upon passage through the optical filter layer. It must again be emphasized that a largest possible flank steepness (that is to say an abrupt as possible a rise from a transmission of zero to a transmission of one) is advantageous for the functionality of the dielectric interference filter in order that the excitation light is suppressed well and the emission spectrum is attenuated as slightly as possible.

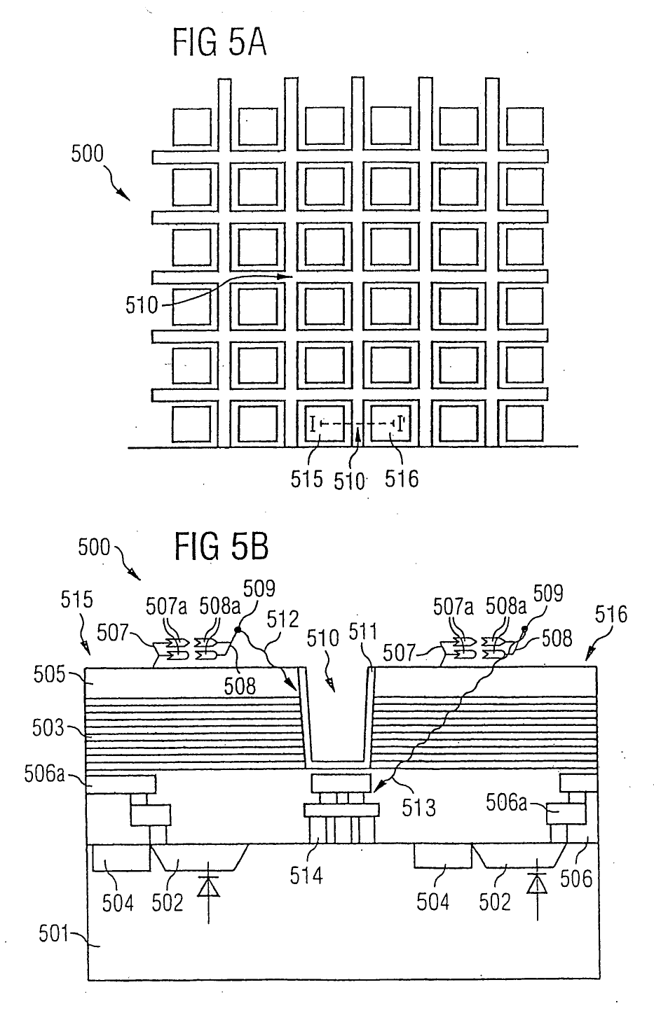

The fluorescence biosensor chip 500 shown in FIG. 5A, FIG. 5B is described below.

FIG. 5A shows a plan view of the fluorescence biosensor chip 500, and FIG. 5B shows a cross-sectional view of part of the fluorescence biosensor chip 500 shown in FIG. 5A along the section line I-I′. The fluorescence biosensor chip 500 shown in FIG. 5A, FIG. 5B is a third preferred exemplary embodiment of the fluorescence biosensor chip according to the invention and differs from the previously described fluorescence biosensor chips 200, 300 only in respect of a few aspects. The text below will not explain the complete functionality of the fluorescence biosensor chip 500, rather the description will focus only on the supplementary features compared with the previously described exemplary embodiments.

FIG. 5B shows a fluorescence biosensor chip 500 having a substrate 501, at least one detection device 502 arranged in or on the substrate 501 and serving for detecting electromagnetic radiation, an optical filter layer 503 an arranged on the substrate 501, and an immobilization layer 505 arranged on the optical filter layer 503 and serving for immobilizing capture molecules. The detection devices 502, the optical filter layer 503 and the immobilization layer 505 are integrated in the fluorescence biosensor chip 500.

The substrate 501 is a p-doped silicon substrate. The detection devices 502 are silicon photodiodes integrated into the substrate 501. The optical filter layer 503 is a dielectric interference filter in accordance with the exemplary embodiment described with reference to FIG. 5A, FIG. 5B. The immobilization layer 505 is a thin gold layer. Beside the silicon photodiodes 502, silicon dioxide regions 504 are introduced into the substrate 501.

Furthermore, a circuit layer 504 is arranged between the substrate 501 and the optical filter layer 503, at least one electrical component 506a being integrated into the circuit layer 504 and the circuit layer 504 being electrically coupled to the at least one detection device 502. This coupling is shown explicitly in FIG. 5B. The integrated circuit elements 506a, which are depicted in FIG. 5B, are electrically conductive connecting means which enable the silicon photodiodes 502 to be coupled to drive electronics.

The fluorescence biosensor chip 500 furthermore has a multiplicity of capture molecules 507, which are coupled to the immobilization layer 505 and are set up in such a way that a molecule 508 to be detected which is complementary to the capture molecule 507 can be coupled to the capture molecules 507.

The reference numeral 507a designates the individual bases of the capture molecules 507 formed as a DNA half strand. As shown in FIG. 5B, molecules 508, likewise DNA half strands, to be detected which are complimentary to the DNA half strands 507 are attached to capture molecules 507. Since the molecules 508 to be detected are also DNA hall strands, the molecules 508 to be detected also have individual bases 508a. Fluorescence markers 509 are coupled to the molecules 508 to be detected.

Furthermore, at least one isolation trench 510 for optically isolating adjacent detection devices 502 is introduced into at least one surface region of the fluorescence biosensor chip 500 which at least one isolation trench 510 extends through the immobilization layer 505 right into a region of the optical filter layer 503, in such a way that a detection device 502 is in each case arranged below each region between two adjacent isolation trenches 510. As shown in FIG. 5B, the at least one isolation trench 510 is covered with a layer made of an absorbent material 511, the absorbent material 511 being set up in such a way that it absorbs electromagnetic radiation.

The functionality of the isolation trench 510 and of the absorbent material 511 introduced in the isolation trench 510 is explained below with reference to FIG. 5B and, in particular, the electromagnetic fluorescence radiation 512 depicted schematically therein, said fluorescence radiation being emitted by the fluorescence marker 509 arranged on the left in FIG. 5B. As discussed above, the various detection devices 502 in the substrate 501 correspond to the sensor pixels on the surface of the immobilization layer 505. Clearly, all those capture molecules 507 which are immobilized on the surface of the immobilization layer 505 belong to that detection device 502 which is essentially arranged below said capture molecule 507. Thus, with reference to FIG. 5B, the left-hand detection device 502 is provided for detecting fluorescence radiation which emerges from the left-hand capture molecule 507 immobilized on the surface of the immobilization layer 505. And the right-hand detection device 502 shown in FIG. 5B serves for detecting fluorescence radiation which originates from a fluorescence marker 509 bound to a molecule 508 to be detected, which molecule 508 to be detected is docked to a capture molecule 507 which is essentially situated above the right-hand detection device 502.

As shown in FIG. 5B, the left-hand fluorescence marker 509 emits electromagnetic fluorescence radiation 512. In accordance with the statements above, this fluorescence radiation, which is an indirect consequence of a hybridization event at the left-hand capture molecule 507 arranged on the surface of the immobilization layer 505, should be detected by the left-hand detection device 502. However, the electromagnetic fluorescence radiation 512 is emitted in a direction such that it is not radiated onto the left-hand detection device 502 shown in FIG. 5B, but rather in the direction of the right-hand detection device 502. If the electromagnetic fluorescence radiation 512 were detected by the right-hand detection device 512, this would corrupt the measurement.

This phenomenon is referred to as optical crosstalk between two adjacent sensor arrays belonging to the left-hand and, respectively, the right-hand detection device 502. The isolation trench 510 partly filled with the absorbent material 511 has the effect of reducing the undesirable phenomenon of optical crosstalk.

As shown in FIG. 5B, although the electromagnetic fluorescence radiation 512 is emitted in the direction of the right-hand silicon photodiode 502 shown in FIG. 5B, this electromagnetic fluorescence radiation 512, on the way to the right-hand silicon photodiode 502, has to traverse the isolation trench 510 and the absorbent material 511 partly filled therein. The absorbent material 511 is set up in such a way that it absorbs electromagnetic radiation in particular in the wavelength range of the fluorescence radiation of the fluorescence markers 509 used. As a result, the electromagnetic fluorescence radiation 512 is absorbed in the absorbent material 511 in the isolation trench 510 and therefore cannot pass to the right-hand detection device 502 shown in FIG. 5B. Optical crosstalk between adjacent sensor arrays is thereby reduced.

As is shown in FIG. 5B, however, the isolation trenches 510 filled with an absorbent material 511 cannot completely prevent optical crosstalk. In this regard, reference shall be made to the electromagnetic fluorescence radiation 513, which is emitted by the right-hand fluorescence marker 509 shown in FIG. 5B. The fluorescence radiation 513 is likewise not emitted in the direction of the essentially underlying detection device 502, but rather in the direction of the detection device 502 arranged on the left of the fluorescence marker 509. On account of the geometrical conditions shown in FIG. 5B, the electromagnetic fluorescence radiation 513 is not absorbed by the absorbent material 511 in the isolation trench 510. These explanations show that the isolation trench 510 and the absorbent material 511 alone do not always completely prevent optical crosstalk.

In order to further reduce optical crosstalk, a barrier layer 514 made of an absorbent material is arranged in at least one region of the circuit layer 504, in such a way that a detection device 502 is in each case arranged below each region between two adjacent barrier layers 514, the absorbent material being set up in such a way that it absorbs electromagnetic radiation. The barrier layer 514 absorbs the electromagnetic fluorescent radiation 513. As a result, the barrier layer 514 reduces the disadvantageous phenomenon of optical crosstalk. In this respect, it should be pointed out that the integrated circuit elements 506a, too, in addition to their electronic functionality (for example as electrically conductive connecting means), can also concomitantly perform the function of the absorbent barrier layer 514. For this purpose, the integrated circuit elements 506a are to be produced from a material which absorbs and/or reflects electromagnetic radiation. The integrated circuit elements 506a may thus realize a dual function: on the one hand, they may serve as electronic circuit elements; on the other hand, they may contribute to reducing the phenomenon of optical crosstalk.

FIG. 5A shows a plan view of the fluorescence biosensor chip 500 in accordance with the exemplary embodiment of the invention described. In particular, the isolation trench 510, which is configured as a contiguous isolation region in accordance with the exemplary embodiment shown, is shown in FIG. 5A. Furthermore, the individual sensor arrays 515, 516, which are defined by the regions between the isolation trenches 510 and are covered with capture molecules 507, are shown in FIG. 5A. In particular, the sensor arrays 515 and 516 are shown, which are shown as an enlarged cross section along the section line I-I′ in FIG. 5B.

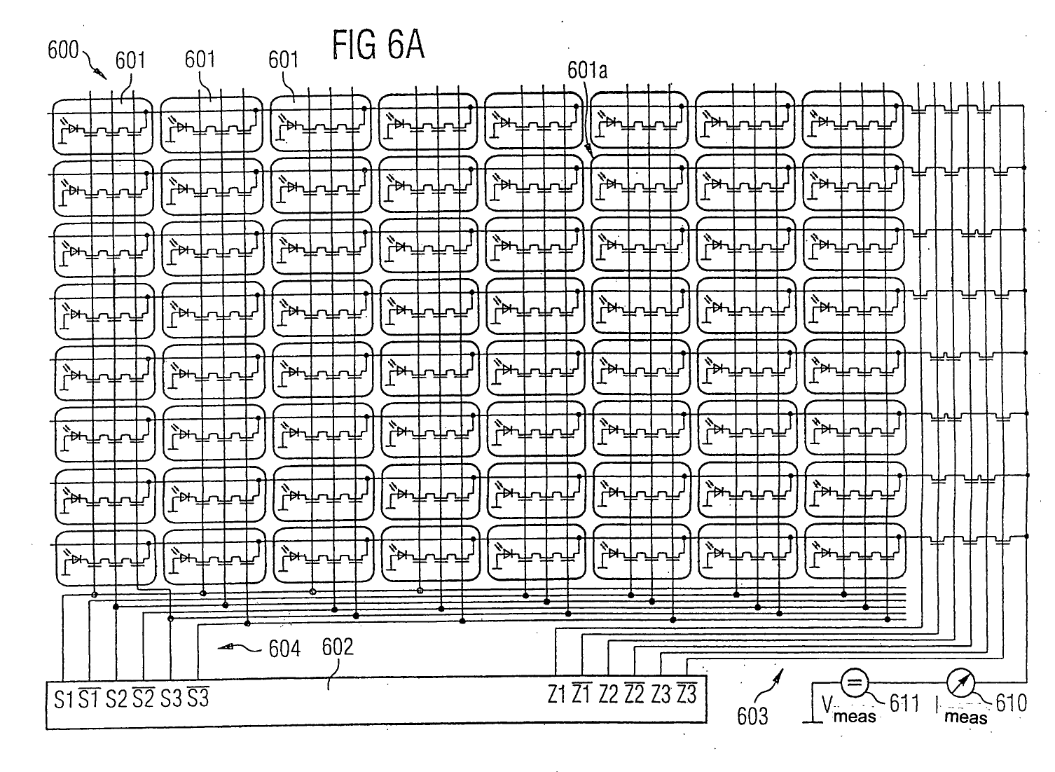

A description is given below of the circuit schematic for the driving and scanning of each individual one of the detection devices in accordance with a preferred exemplary embodiment of the fluorescence biosensor chip 600, which is shown schematically in plan view in FIG. 6A. FIG. 6A shows an essentially matrix-type arrangement of sensor arrays 601. In this case, the illustration shown in FIG. 6A essentially corresponds to the illustration of the fluorescence biosensor chip 500 in FIG. 5A. What FIG. 5A does not show and FIG. 6A shows in detail is the circuitry by means of which each individual one of the sensor arrays 601 of the fluorescence biosensor chip 600 can be driven. The driveability of a specific row and the driveability of a specific column of the sensor arrays 601 arranged in matrix-type fashion is realized by means of the drive circuit 602.

By means of the drive circuit 602, each individual sensor array 601 can be driven by means of the row select lines 603 and the column select lines 604.

It must be emphasized that the number of row select lines 603 (six in the example) and column select lines 604 (six in the example) depends on the number of sensor arrays 601. If the number of columns of the sensor array is equal to 2^{m}, then 2m row select lines 603 are necessary. If the number of columns of the sensor arrays 601 is equal to 2ⁿ, then 2n column select lines 604 are necessary for the sequential driving of all the columns.

The example shown in FIG. 6A shows 8=2³ and 8=2³ columns of sensor arrays 601, with the result that 6=2×3 row select lines 603 and 6=2×3 column select lines 604 are provided.

As shown in FIG. 6A, the individual row select lines 603 are partly dependent on one another. The row select lines 603 are designated by Z1, \overline{Z1}, Z2, \overline{Z2}, Z3 and \overline{Z3}. This means that if the signal of the row select line Z1 is at a logic value “1”, the signal of the row select line \overline{Z1} is at a logic value “0”, and if the signal of the row select line Z1 is at a logic value “0”, the signal of the row select line \overline{Z1} is at a logic value “1”. The signals on Z1 and on \overline{Z1} are thus always at mutually opposite logic values. Analogously, the row select lines 603 Z2 and \overline{Z2} are also at mutually complementary values. The row select lines 603 Z3 and \overline{Z3} are also at mutually complementary values. The same applies to the column select lines 604, which are designated by S1, \overline{S1}, S2, \overline{S2}, S3 and \overline{S3}. The signals on S1 and \overline{S1} are always at mutually complementary logic values, the signals on S2 and \overline{S2} are always at mutually complementary values, and the signals on S3 and \overline{S3} are always at mutually complementary values.

Each of the sensor arrays 601 is coupled to three of the six row select lines 603 in accordance with the exemplary embodiment shown in FIG. 6A and is coupled to three of the six column select lines 604 in accordance with the exemplary embodiment shown in FIG. 6A.

An explanation is given below by way of example of how the selected sensor array 601a shown in FIG. 6A can be driven by means of the drive circuit 602 shown.

As shown in FIG. 6B, the selected sensor array 601a is coupled to a first, a second and a third row select line 603a, 603b and 603c. Referring to FIG. 6A again, the first row select line 603a is Z1, the second row select line 603b is Z2 and the third row select line 603c is \overline{Z3}. Furthermore, the selected sensor array 601a is coupled to a first, a second and a third column select line 604a, 604b, 604c. Referring to FIG. 6A, these are the first column select line 604a \overline{S1}, the second column select line 604b S2 and the third column select line 604c \overline{S3}.

Arranged within the selected sensor array 601a is a photodiode 605, which essentially corresponds to one of the detection devices 502 shown in FIG. 5A.

FIG. 6B schematically indicates, by means of two arrows bearing the reference numeral 606, that the photodiode 605 is set up in such a way that electromagnetic fluorescence radiation can be detected thereby. If electromagnetic radiation 606 impinges on the photodiode 605, then the electrical properties of the photodiode 605 change in a characteristic manner and an electrical signal is present at the source of a first transistor 607a coupled to the photodiode 605. Said signal can pass through the first transistor 607a only when a voltage signal is present at the gate region of the first transistor 607a and a conductive channel is therefore formed between the source region and the drain region, i.e. when a signal having a logic value “1” is present on the first column select line 604a, that is to say when a signal having a logic value “1” is present on \overline{S1}. If this is the case, then the electrical signal of the photodiode 605 can pass from the source region to the drain region of the transistor 607a and from there passes further to the source region of the second transistor 607b.

The electrical signal which is present at the source region of the second transistor 607b can then pass to the drain region of the second transistor 607b only when a voltage signal is present at the gate region of the transistor second 607b and a conductive channel is therefore formed between the source region and the drain region, i.e. when the electrical signal present on the second column select line 604b has a logic value “1”, that is to say when a signal having a logic value “1” is present on S2. In this case, the electrical signal passes from the source region of the second transistor 607b to the drain region of the second transistor 607b and from there to the source region of the third transistor 607c. The electrical signal present at the source region of the third transistor 607c can pass to the drain region of the third transistor 607c only when a voltage signal is present at the gate region of the third transistor 607c and a conductive channel is therefore formed between the source region and the drain region. i.e. when an electrical signal having a logic value “1” is present on the third column select line 604c and thus on \overline{S3}. If this is the case, then the electrical signal passes from the source region of the third transistor 607c to the drain region of the third transistor 607c and from there to the electrical node 608. The sixth column of sensor arrays 601, which has the selected sensor array 601a, is thereby selected. In other words, the column of sensor arrays 601 which is to be selected is dependent on the logic values present on the column select lines 603.

In order to select the selected sensor array 601a, the selection of the correct row of sensor arrays 601 is also necessary in addition to the selection of the corresponding column of sensor arrays 601. A description is given below of how a row of sensor arrays 601 can be selected. The electrical node point 608 shown in FIG. 6B is coupled to the source region of a fourth transistor 609a. The electrical signal present at the source region of the fourth transistor 609a can pass to the drain region of the fourth transistor 609a only when a voltage signal is present at the gate region of the fourth transistor 609a and a conductive channel is therefore formed between the source region and the drain region, i.e. precisely when an electrical signal having a logic value “1” is present on the first row select line 603a, which is coupled to the gate region of the fourth transistor 609a, that is to say when an electrical signal having a logic value “1” is present on Z1. If this is the case, then the electrical signal present at the source region of the fourth transistor 609a can pass to the (drain region of the fourth transistor 609a and from there can pass to the source region of the fifth transistor 609b. The electrical signal present at the source region of the fifth transistor 609b can pass to the drain region of the fifth transistor 609b precisely when the second row select line 603b coupled to the gate region of the fifth transistor 609b is occupied by an electrical signal having a logic value “1”. This means that an electrical signal having a logic value “1” has to be present on the second row select line 603b designated by Z2. In this case, the electrical signal present at the source region of the fifth transistor 609b passes to the drain region of the fifth transistor 609b and from there to the source region of the sixth transistor 609c coupled thereto. Once again the electrical signal present at the source region of the sixth transistor 609c can pass to the drain region of the sixth transistor 609c only when a voltage signal is present at the gate region of the sixth transistor 609c and a conductive channel is therefore formed between the source region and the drain region, i.e. when an electrical signal having a logic value “1” is present on the third row select line 603c, that is to say when an electrical signal having a logic value “1” is present on \overline{Z3}. It is only in this case that the electrical signal present at the source region of the sixth transistor 609c can pass to the drain region of the sixth transistor 609c. If this condition is also met, then the second row of sensor arrays 601 associated with the selected sensor array 601a is selected.

The selected sensor array 601a is thus selected precisely when an electrical signal having a logic value “1” is in each case present on the first column select line 604a \overline{S1} and on the second column select line 604b S2 and on the third column select line 604c \overline{S3}and on the first row select line 603a Z1 and on the second row select line 603b Z2 and on the third row select line 603c \overline{Z3}. If an electrical signal having a logic value “0” is present even only on one of the six select lines 603a, 603b, 603c, 604a, 604b, 604c mentioned, then the corresponding sensor array is not selected. If both row and column of the selected sensor array 601a are selected, then the electrical signal detected by the photodiode 605 passes to the means for detecting the electric current 610 or to the means for detecting the electrical voltage 611. As a result, a specific selected sensor array 601a can be selected and the strength of the electrical sensor signal present at the detection device 605 of the selected sensor array 601a can be read out.

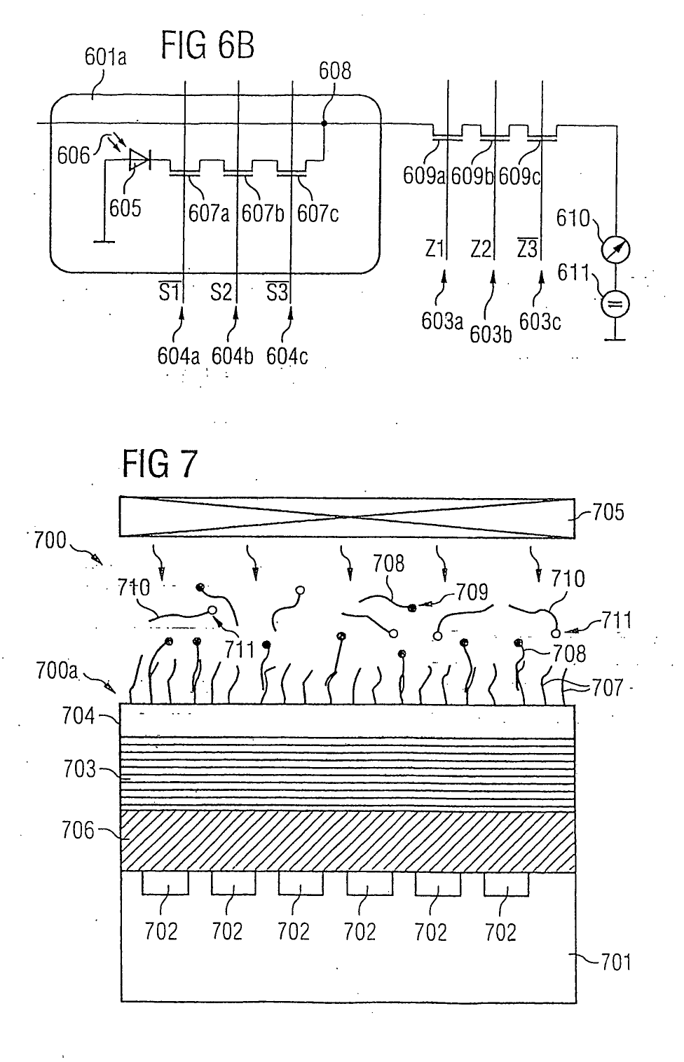

FIG. 7 shows a preferred exemplary embodiment of a fluorescence biosensor chip arrangement 700, which is explained in more detail below. The fluorescence biosensor chip arrangement 700 has a fluorescence biosensor chip 700a and an electromagnetic radiation source 705. The fluorescence biosensor chip 700a has a substrate 701, six detection devices 702 arranged in the substrate 701 and serving for detecting electromagnetic radiation of a first wavelength range, an optical filter layer 703 arranged on the substrate 701 and serving for absorbing and/or reflecting electromagnetic radiation of a second wavelength range, and an immobilization layer 704 arranged on the optical filter layer 703 and serving for immobilizing capture molecules. The detection devices 702, the optical filter layer 703 and the immobilization layer 704 are integrated in the fluorescence biosensor chip 700a. The electromagnetic radiation source 705 is set up in such a way that a surface region of the fluorescence biosensor chip 700a can be irradiated with electromagnetic radiation of a third wavelength range by means of the electromagnetic radiation source 705.

As shown in FIG. 7, the fluorescence biosensor chip 700a has a circuit layer 706 arranged between the substrate 701 and the optical filter layer 703.

The electromagnetic radiation source 705 is a laser.

In accordance with the exemplary embodiment of the fluorescence biosensor chip arrangement 700 as shown in FIG. 7, the fluorescence biosensor chip 700a has a multiplicity of capture molecules 707, which are coupled to the immobilization layer 704 and are set up in such a way that a molecule 708 to be detected which is complementary to the capture molecule 707 call be coupled to the capture molecules 707. Each molecule 708 to be detected has a fluorescence marker 709 which is set up in such a way that it at least partially absorbs electromagnetic radiation of the third wavelength range and, after absorption has been effected, emits electromagnetic radiation of a fourth wavelength range. At least part of the third wavelength range lies outside the fourth wavelength range and at least part of the fourth wavelength range lies within the first wavelength range. At least part of the first wavelength range lies outside the second wavelength range. FIG. 7 also shows molecules 710 with fluorescence markers 711 which are not complementary to the capture molecules 707 and therefore do not couple thereto.

1-27. (Canceled).

28. A fluorescence biosensor chip comprising:
a substrate;
at least one electromagnetic radiation detection device arranged in or on the substrate;
an optical filter layer arranged on the substrate; and
an immobilization layer arranged on the optical filter layer and immobilizing capture molecules,
wherein the electromagnetic radiation detection device, the optical filter layer, and the immobilization layer are integrated in the fluorescence biosensor chip.

29. The fluorescence biosensor chip as claimed in claim 28, wherein the substrate is produced from silicon material.

30. The fluorescence biosensor chip as claimed in claim 28, wherein the at least one electromagnetic radiation detection device has a photodiode arranged such that electromagnetic radiation of a first wavelength range is detected.

31. The fluorescence biosensor chip as claimed in claim 30, wherein the optical filter layer reflects and/or absorbs electromagnetic radiation of a second wavelength range, at least part of the first wavelength range lying outside the second wavelength range.

32. The fluorescence biosensor chip as claimed in claim 28, wherein the optical filter layer has at least one bandpass filter and/or at least one cut-off filter.

33. The fluorescence biosensor chip as claimed in claim 32, wherein the bandpass filter is a dielectric interference filter having a layer sequence comprising at least two materials, a first material having a high refractive index and a second material having a low refractive index.

34. The fluorescence biosensor chip as claimed in claim 32, wherein the cut-off filter is a color filter produced from an organic material.

35. The fluorescence biosensor chip as claimed in claim 33, wherein the first material is one or a combination of chemical elements and compounds selected from the group consisting of titanium oxide, silicon nitride, hafnium oxide, zirconium oxide, aluminum oxide, polysilicon, indium tin oxide, and silicon dioxide.

36. The fluorescence biosensor chip as claimed in claim 32, wherein the second material is one or a combination of chemical elements and compounds selected from the group consisting of titanium oxide, silicon nitride, hafnium oxide, zirconium oxide, aluminum oxide, polysilicon, indium tin oxide, and silicon dioxide.

37. The fluorescence biosensor chip as claimed in claim 28, wherein the immobilization layer has one or a combination of materials selected from the group consisting of silicon dioxide, silicon nitride, gold, and organic material.

38. The fluorescence biosensor chip as claimed in laim 28, further comprising a circuit layer arranged between the substrate and the optical filter layer and electrically coupled to the at least one electromagnetic radiation detection device, wherein at least one electrical component is integrated into the circuit layer.

39. The fluorescence biosensor chip as claimed in claim 38, wherein the circuit layer electrically drives the at least one electromagnetic radiation detection device.

40. The fluorescence biosensor chip as claimed in claim 28, further comprising a multiplicity of capture molecules coupled to the immobilization layer, wherein a molecule that is to be detected and is complementary to the capture molecules can be coupled to each of the capture molecules.

41. The fluorescence biosensor chip as claimed in claim 40, wherein the capture molecules are selected from the group consisting of nucleic acids, peptides, proteins, and low-molecular-weight compounds.

42. The fluorescence biosensor chip as claimed in claim 40, wherein a surface section of the immobilization layer is free of the capture molecules so that a noise signal can be tapped off at the at least one electromagnetic radiation detection device arranged below the surface section.

43. The fluorescence biosensor chip as claimed in claim 40, wherein each molecule to be detected has at least one fluorescence marker that absorbs electromagnetic radiation of a third wavelength range and, after absorption has been effected, emits electromagnetic radiation of a fourth wavelength range;
wherein at least part of the third wavelength range lies outside the fourth wavelength range, and at least part of the fourth wavelength range lies within the first wavelength range.

44. The fluorescence biosensor chip as claimed in claim 43, wherein the fluorescence marker is selected from the group of materials consisting of coumarin, FITC, Cy2, Alexa Fluor 488, BODIPY 493, Rhodamine 123, R6G, TET, JOE, HEX, BODIPY 530, Alexa 532, R-phycoerythrin, TRITC, Cy3, TAMRA, Texas Red, ROX, BODIPY 630, and Cy5.

45. The fluorescence biosensor chip as claimed in claim 30, wherein at least one isolation trench for optically isolating adjacent electromagnetic radiation detection devices is introduced into at least one surface region of the fluorescence biosensor chip, the at least one isolation trench extending through the immobilization layer into a region of the optical filter layer such that an electromagnetic radiation detection device is arranged below each region between each of two adjacent isolation trenches.

46. The fluorescence biosensor chip as claimed in claim 45, wherein at least part of the surface of the at least one isolation trench is covered with a layer made of an absorbent material, or the at least one isolation trench is filled with the absorbent material, wherein the absorbent material absorbs or reflects electromagnetic radiation at least of the first wavelength range.

47. The fluorescence biosensor chip as claimed in claim 38, wherein a barrier layer made of an absorbent material is provided in at least one region of the circuit layer, and an electromagnetic radiation detection device is arranged below each region between each of two adjacent barrier layers, wherein the absorbent material absorbs or reflects electromagnetic radiation at least of a respective wavelength range.

48. A fluorescence biosensor chip arrangement comprising:
a fluorescence biosensor chip having:
a substrate;
at least one electromagnetic radiation detection device arranged in or on the substrate and detecting radiation of a first wavelength range;
an optical filter layer arranged on the substrate and absorbing and/or reflecting electromagnetic radiation of a second wavelength range; and
an immobilization layer arranged on the optical filter layer and immobilizing capture molecules,
wherein the electromagnetic radiation detection device, the optical filter layer and the immobilization layer are integrated in the fluorescence biosensor chip; and
an electromagnetic radiation source irradiating a surface region of the fluorescence biosensor chip with electromagnetic radiation of a third wavelength range.

49. The fluorescence biosensor chip arrangement as claimed in claim 48, wherein the electromagnetic radiation source is selected from the group consisting of a laser, a light-emitting diode, a gas discharge lamp, and an incandescent lamp.

50. The fluorescence biosensor chip arrangement as claimed in claim 48, wherein the fluorescence biosensor chip has a multiplicity of capture molecules coupled to the immobilization layer, wherein a molecule that is to be detected and is complementary to the capture molecules can be coupled to each of the capture molecules.

51. The fluorescence biosensor chip arrangement as claimed in claim 50, wherein the molecules to be detected and/or the capture molecules have a fluorescence marker that at least partially absorbs electromagnetic radiation of the third wavelength range and, after absorption has been effected, emits electromagnetic radiation of a fourth wavelength range;
wherein at least part of the third wavelength range lying outside the fourth wavelength range, and at least part of the fourth wavelength range lying within the first wavelength range.

52. The fluorescence biosensor chip arrangement as claimed in claim 48, wherein at least part of the first wavelength range lies outside the second wavelength range.

53. The fluorescence biosensor chip arrangement as claimed in claim 50, wherein the electromagnetic radiation source emits electromagnetic radiation incident at a predeterminable angle with respect to the direction of the normal to the optical filter layer.

54. The fluorescence biosensor chip arrangement as claimed in claim 51, wherein the electromagnetic radiation source emits electromagnetic radiation in pulses, and the electromagnetic radiation detection devices detect the electromagnetic radiation emitted by the fluorescence markers in time intervals between the pulses.
